(19) United States
(12) Patent Application Publication
(10) Pub. No.: US 2025/0018919 A1
(43) Pub. Date: Jan. 16, 2025

(54) METHOD FOR DETECTING A MALFUNCTION OF A VALVE

(71) Applicant: ZF CV Systems Global GmbH, Bern (CH)

(72) Inventors: Tobias HAUSCHILD, Seelze (DE); Matthias KEMMERLING, Braunschweig (DE); Mirko BRÜTT, Springe (DE); Sriganesh RAJAGOPAL, Chennai (IN)

(73) Assignee: ZF CV Systems Global GmbH, Bern (CH)

(21) Appl. No.: 18/769,938

(22) Filed: Jul. 11, 2024

(30) Foreign Application Priority Data
Jul. 14, 2023 (DE) 10 2023 206 706.4

(51) Int. Cl. B60T 17/22; B60T 13/68; B60T 13/74

(52) U.S. Cl. CPC B60T 17/221; B60T 13/686; B60T 13/745

(57) ABSTRACT

A method is provided for detecting a malfunction of a valve (46) of a braking device (10) for a processing machine, where the braking device (10) has a brake that can be actuated via the valve (46) and a transmission portion (22). The method includes triggering (I.1) the valve (46) of the braking device (10) and determining a state variable in the transmission portion (22). The method further comprises a comparison (III.1) of the determined state variable to a reference variable and a detection (IV.1) of a malfunction of the valve (46) based on a result of the comparison.

### RELATED APPLICATIONS

This application claims the benefit of and right of priority under 35 U.S.C. § 119to German Patent Application no. 10 2023 206 706.4, filed on 14 Jul. 2023, the contents of which are incorporated herein by reference in its entirety.

### TECHNICAL FIELD

The present invention relates to a method for detecting a malfunction of a valve of a braking device for a processing machine. The present invention further relates to a control device for a braking device of a processing machine, being configured so as to carry out such a method, and a braking device having such a control device.

### BACKGROUND

Braking devices for processing machines, for example for trailers of processing machines, are often operated with pneumatic pressure and controlled via valves. A braking device for controlling a brake pressure of a trailer of a processing machine is known, for example, from DE 10 2019 100 869A1. The braking devices of the processing machines can have redundant components, for example redundant valves, in order to increase safety. To ensure smooth operation, it is necessary that the valves of such a braking device function as intended. The problem addressed by the present invention was therefore to provide a method for detecting a malfunction of a valve of a braking device.

### SUMMARY

The present invention relates to a method for detecting a malfunction of a valve of a braking device for a processing machine. The processing machine can comprise a towing vehicle and additionally a trailer. The towing vehicle can be a tractor or a wheeled loader, for example. The trailer can be a vehicle that does not have its own drive and is pulled by another vehicle, for example by the towing vehicle. The braking device can be configured so as to initiate a braking of the processing machine, for example of a towing vehicle and alternatively or additionally a trailer of the processing machine. The braking device can initiate such braking by pneumatic pressure, hydraulic pressure, a mechanical component, for example a piston, and/or an electrical component, for example an electric motor. The braking device can be configured so as to initiate a braking via a wireless connection. The braking device can be operatively connected to a brake, which can brake a towing vehicle and, alternatively or additionally, a trailer of the processing machine. In one embodiment, the braking device is arranged in a towing vehicle of the processing machine and is configured so as to actuate a brake of a trailer of the processing machine. The braking device is configured so as to actuate a brake, for example the brake described above, via the valve and a transmission portion. The transmission portion can be a portion that provides an operative connection between the valve and the brake. The transmission portion can provide a direct or indirect connection between the valve and the brake. The transmission portion can comprise mechanical, pneumatic, or hydraulic connection elements, for example tubes or other valves. The actuation of the brake can be a closing or an opening of the brake.

The valve of the braking device can be configured as a solenoid valve, for example as a 3/2-way solenoid valve or as a 2/2-way solenoid valve. The valve can be pneumatically or hydraulically actuated. The valve can be configured so as to conduct a hydraulic or pneumatic pressure forward, via which a brake of the processing machine can be actuated directly or indirectly. A malfunction of the valve can be a limited functionality of the valve, which can be accompanied by an impairment of the braking functionality of the braking device. A malfunction of the valve can be caused in the valve, in the triggering of the valve, or in the lines leading to and away from the valve. A malfunction of the valve can occur when the valve does not respond properly when triggered. A malfunction of the valve can be a clamping, non-opening, or a non-closing of the valve. A malfunction of the valve can be due to a leakage of the valve and, alternatively or additionally, a line that leads away from or toward the valve. A malfunction of the valve can manifest itself in a conduction of pressure that is too high or too low or of a mass flow that is too high or too low.

The method comprises a triggering of the valve of the braking device in order to open or close the valve, for example. The valve can be controlled electronically, mechanically, pneumatically, or hydraulically, for example. By triggering the valve, a connection can be established between different inputs and outputs of the valve. The valve can be triggered in response to a braking signal, which can be initiated by a driver and, alternatively or additionally, by a control device of the processing machine. The method further comprises a determination, for example a measurement, of a state variable in the transmission portion. The state variable can be a pressure, a temperature, a speed, a mass flow density, a density, a heat flow, an electrical parameter, and/or a magnetic parameter. The state variable is determined in the transmission portion, for example by means of a sensor or a plurality of sensors.

The method comprises a step of comparing the determined state variable to a reference variable. The reference variable can be a fixedly defined or adjustable variable. The reference variable can define a high or low limit for the state variable, wherein a state variable above the high limit or a state variable below the low limit can indicate a malfunction. The reference variable can also be a value range, wherein a state variable outside the value range can indicate a malfunction. The comparison can include a determination of whether a state variable is greater than, less than, or equal to the reference variable. The comparison can include a subtraction of the state variable from the reference variable or of the reference variable from the state variable. The comparison can include a determination of the distance of a state variable from the reference variable. The comparison can also include a determination of an output value of a function that has the state variable as an input value.

The method comprises a step of detecting a malfunction of the valve based on a result of the comparison of the determined state variable and the reference variable. The detection can comprise the forwarding and, for example, outputting of a fault signal. The fault signal can be forwarded and output to a driver and, alternatively or additionally, to a component of the processing machine, for example the control device. As a result of the detection, a control device can carry out corrective measures, for example outputting a warning signal or adjusting a braking operation. The described method therefore allows for a detection of a malfunction of a valve of a braking device of a processing machine in a simple manner. Valves can represent safety-critical components of a braking device. By comparing a state variable in the transmission portion, a malfunction can be detected quickly, precisely, and cost-effectively.

According to one embodiment of the method, the braking device comprises a further valve for actuating the brake via a further transmission portion. The one brake can thus be actuated via two valves. When only one of the valves triggers the brake, the brake can be actuated. When both valves trigger the brake, the brake can be actuated. The further transmission portion can be configured completely or partially separately from the transmission portion. However, the further transmission portion can also partially correspond to the transmission portion. Both transmission portions can therefore at least partially have a common portion. With regard to the design of the further valve and the further transmission portion, reference is made to the above explanations regarding the valve and the transmission portion.

In the context of this embodiment, the method comprises a step of further triggering the further valve of the braking device. The further triggering of the further valve can take place independently of the triggering of the valve. The further triggering of the further valve can also be coupled to the triggering of the valve, for example it can correspond thereto. The method of this embodiment further comprises a step of further determining a further state variable in the further transmission portion. The further determination can occur simultaneously or at a temporal delay from the first determination. The further determination can be carried out by means of the same or a different apparatus as the determination. The further state variable can be a different one than or the same as the state variable. The method of this embodiment further comprises a step of further comparison of the determined further state variable to a reference variable. The comparison of the further state variable can use a different reference value or the same reference value for the comparison, as is the case when comparing the state variable. The method of this embodiment further comprises a step of further detecting a malfunction of the further valve based on a result of the further comparison. With regard to the possible configuration of the further triggering, the further determination, the further comparison, and the further detection, reference is made to the above explanations in connection with the triggering, determination, comparison, and detection.

The method of this embodiment is therefore also suitable for detecting malfunctions of a braking device having at least two valves, which are configured as redundant valves, for example. Two valves ensure a safe operation of the braking device. The braking device can be configured such that the further valve can trigger a braking function if the first valve indicates a malfunction. The braking device can also be configured such that the first valve can trigger a braking function if the further valve indicates a malfunction. By detecting a malfunction of one of the two valves, a redundant configuration can be operated reliably and safely. The further triggering, further determination, further comparison, and further detection can be carried out together with the triggering, determination, comparison, and detection in a single check cycle. Alternatively, they are carried out in a separate check cycle, which can follow a check cycle in which the other steps are carried out. A check cycle can always be carried out when a parking brake function is actuated.

According to one embodiment of the method, the transmission portion and the further transmission portion comprise a common transmission portion. In the context of this embodiment, the state variable and the further state variable are determined in this common transmission portion. A common portion can comprise a pneumatic, hydraulic, or other line, with which the two valves are connected. The two transmission portions can be merged via a shuttle valve in order to form the common transmission portion behind the shuttle valve. When the two transmission portions are merged prior to connection with the brake, they can have a common transmission portion. In the method of this embodiment, the step of determination and the step of further determination of a state variable comprises the determination of a state variable in the common transmission portion. The step of determination and the step of further determination can occur simultaneously or at a temporal delay. By determining the state variables in the common transmission portion, the number of components can be reduced. For example, only a single sensor may be provided for this purpose. In an alternative embodiment, the transmission portion and the further transmission portion, in which the state variable and the further state variable are determined, are configured separately from one another. For example, the variables can be determined directly behind the respective valve by means of a sensor device.

According to one embodiment of the method, the step of further triggering the further valve takes place temporally after the triggering of the valve. The further triggering can be carried out after the triggering has been carried out. However, further triggering can also be started after the start of the triggering, but before the triggering is no longer carried out. The triggering can take place at a predefined time after the first triggering. The further triggering of the further valve can take place after the first triggering with a temporal offset at a time from which an effect of the first triggering is to be expected. A further triggering can take place after the first triggering with a temporal offset at a time from which a change in the determined state variable, for example a pressure drop or pressure increase, is to be expected. The period between triggering and further triggering can be 100 to 1000 milliseconds. The period between triggering and further triggering can be between 0 and 1 second or more than 1 second. By triggering the further valve temporally after the first valve has been triggered, it is possible to determine the functionality of the individual valves in the braking device. A change in the state variable can thus be attributed to one of the valves. By actuating the valves with a temporal offset, it is thus possible to detect a malfunction of an individual valve.

According to one embodiment of the method, the detection of a malfunction of the valve comprises a detection of whether the determined state variable is greater than the reference variable. If a state variable has multiple dimensions, [one can be greater than, sic] a single dimension or can comprise all dimensions of the state variable. By detecting whether the determined state variable is greater than a reference variable, a particularly simple and reliable method for detecting a malfunction is achieved. The reference variable can be the maximum brake pressure at which a brake is opened. When the determined state variable is greater than this reference variable, the brake cannot be opened, and there is a malfunction. A malfunction can be detected particularly reliably by such a reference variable.

According to one embodiment of the method, the determination of a state variable in the transmission portion comprises a determination of a pressure in the transmission portion. A determination of a pressure can take place via a pressure sensor. A determination via a pressure sensor can take place directly on the transmission portion. A determination via a pressure sensor can take place via a pressure line that is operatively connected to the transmission portion. A determination of a pressure can also take place via a model calculation. A determination of a pressure can take place, for example, by determining a speed and a temperature. The speed and temperature can be input variables of a calculation model, which has the determined pressure as an output variable. A pressure can be a total pressure, static pressure, or dynamic pressure. A pressure can also be a partial pressure of a component of a fluid. By determining a pressure, the effect of one or more valves on a pressure-controlled brake can be determined particularly easily, quickly, accurately, and reliably. A detection of a malfunction can therefore be particularly simple, fast, precise, and reliable. A determination of a pressure by using a pressure sensor can be particularly cost-effective, for example by utilizing an already existing pressure sensor of the braking device.

According to one embodiment of the method, the state variable is determined after the triggering with a time delay representing a waiting period. A waiting period can be between 100 and 1000 milliseconds. A waiting period can be between 0 and 1 second or more than 1 second. A waiting period can be a time that elapses between the triggering and the determination of the state variable. The time between the determination and the triggering can be shorter than the time between a triggering and a further triggering. By a temporal offset of the determination relative to the triggering, it is possible to also detect time-delayed effects of the triggering on the state variable. When a triggering causes a pressure drop over time, a more precise and relevant determination can be carried out by a temporally offset determination. In this embodiment, the method can thus be configured more reliably and can take into account the temporal curves.

According to one embodiment of the method, the braking device comprises a parking brake module with the valve for parking the processing machine and a service brake module for service-braking the processing machine. The parking brake module can comprise at least one valve. The parking brake module can comprise two valves, for example the valve described above and the further valve described above, which can be switched redundantly, for example. A parking brake module can be a module of the braking device, which is configured so as to initiate a parking brake. The parking brake module can be triggered by a control device. A parking brake can prevent the processing machine from rolling away when it is parked. A service brake module can be a module of the braking device, which is configured so as to initiate a service-braking. The service brake module can be triggered by a control device. A service brake can be a braking in the driving operation of the processing machine, which can be initiated by a driver via a brake lever or brake pedal, for example. The parking brake module and the service brake module can trigger the same brake. The service brake module can have an influence on the determined state variable in the transmission portion, for example it can increase or decrease it.

The method of this embodiment comprises a step of checking whether the service brake module is operated above a limit value. The operation of the service brake module above the limit value can result in the service brake module outputting a variable above a limit value that, for example, has an influence on the state variable in the transmission portion above a limit value. The limit can refer to an input variable or an output variable of the service module. The limit value can also relate to a variable within the service brake module. The limit value can relate to an internal pressure of the service brake module. The limit value can be a pressure, a temperature, a speed, a mass, a mass flow, and/or a further state variable. By checking whether the service brake module is operated above a limit value, it can be checked whether a malfunction can be reliably detected based on the determined state variable. When the service brake module has an influence on the determined state variable, operation thereof can falsify namely the state variable in the transmission portion. By checking whether a service brake module is operated above the limit value, an accurate and safe determination of a malfunction of the valve is therefore made possible. In one embodiment, the present method is only carried out when the service brake module is not operated above the limit value.

The present invention further relates to a control device for a braking device of a processing machine, which is configured, i.e., specifically set up, for example programmed, in order to carry out the method according to one of the embodiments described above. The control device can be a part of the braking device or it can be provided separately therefrom. The control device can have one or more interfaces in order to communicate accordingly with the different components of the braking device for carrying out the method, for example via a CAN bus. The control device can comprise one or more components that can be provided at the same or different locations. The present invention further relates to a braking device for a processing machine having such a control device. The braking device can comprise a housing in which all components of the braking device can be arranged. With regard to the configuration and advantages of the individual features, reference is made to the above explanations in connection with the method for detecting a malfunction of a valve of the braking device.

### BRIEF DESCRIPTION OF THE FIGURES

FIG. 1 schematically illustrates a braking device for a processing machine according to one embodiment of the present invention.

FIG. 2 shows a flowchart of a method for detecting a malfunction of a valve of the braking device from FIG. 1 according to one embodiment of the present invention.

FIG. 3 schematically illustrates brake pressure curves and control signals in the braking device from FIG. 1 when carrying out the method from FIG. 2.

FIG. 4 schematically illustrates further brake pressure curves and control signals in the braking device from FIG. 1.

### DETAILED DESCRIPTION OF EMBODIMENTS

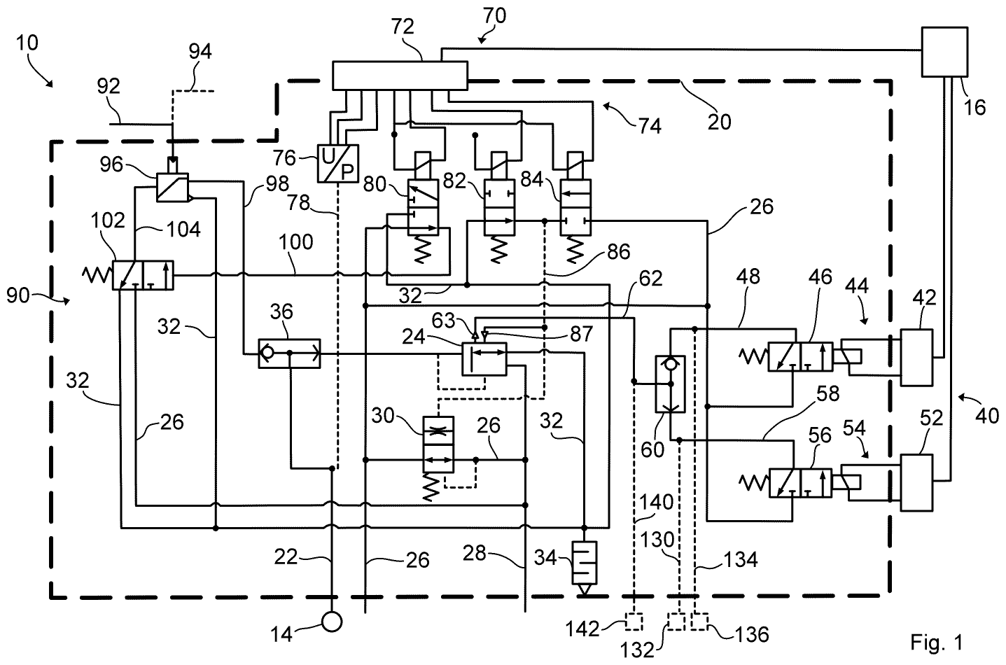

FIG. 1 schematically illustrates a braking device 10 for a processing machine according to one embodiment of the present invention. The braking device 10 comprises a service brake module 70, a parking brake module 40, a redundancy module 90, a brake 14, a control device 16, and a housing 20. The brake 14 is configured so as to brake a processing machine. In the present embodiment, the brake 14 is arranged in a trailer of the processing machine and configured so as to brake it. The braking device 10 is supplied with pneumatic pressure via a pressure input line 26 and a pressure output line 28. The pneumatic pressure in the braking device 10 can be discharged via a ventilation line 32 and a sound absorber 34. The service brake module 70, the parking brake module 40, and the redundancy module 90 are configured so as to actuate the brake 14 with pneumatic pressure via the brake pressure output line 22. The brake pressure output line 22 forms at least a part of a transmission portion and a further transmission portion.

The braking device 10 further comprises a first relay valve 24, a break-off valve 30, and a brake shuttle valve 36. The first relay valve 24 is configured so as to conduct a pressure to the brake pressure output line 22 as a function of the service brake module 70 and the parking brake module 40. The first relay valve 24 conducts pressure forward when the service brake module 70 applies a pressure on the valve 24, and in turn does not conduct pressure forward when the parking brake module 40 applies a pressure on the valve 24. The break-off valve 30 connects the pressure input line 26 to the pressure output line 28 and is triggered via a control pressure line 86 of the service brake. In the event of a leak in the pneumatic system, it throttles a fluid flow in order to avoid a sudden pressure drop.

The parking brake module 40 is configured so as to trigger the first relay valve 24 via a first input 63, a first parking brake valve 46, and a second parking brake valve 56 and thus to provide a parking brake function. The service brake module 70 is configured so as to trigger the first relay valve 24 via a second input 87 as a function of a braking signal of the processing machine in order to brake the trailer of the processing machine during operation. In addition, the service brake module 70 is configured so as to determine via a pressure sensor 76 a brake pressure in the brake pressure output line 22 via a sensor pressure line 78. The redundancy module 90 is configured so as to provide a redundant braking function via a redundancy valve 102 and a second relay valve 96. For this purpose, a hydraulic input line 92 is provided, via which the brake 14 can be triggered in the event of a malfunction of the service brake module 70.

The control device 16 is configured so as to control the parking brake module 40 via a first parking jack 42 and a second parking jack 52. The control device 16 is further configured so as to control the service brake module 70 via an operating jack 72. The control device 16 is further configured so as to receive signals of the pressure sensor 76 of the service brake module 70 via the operating jack 72 and thus to determine a pressure in the brake pressure output line 22.

The parking brake module 40 comprises the first parking brake valve 46 and the second parking brake valve 56, which are connected in parallel and configured in each case as a 3/2-way solenoid switch valve. The first parking brake valve 46 can be adjusted via the first parking jack 42 and a first valve electronics 44 by means of the control device 16. The first parking brake valve 46 is connected to a shuttle valve 60 of the parking brake module 40 via a first brake control line 48. The second parking brake valve 56 can be adjusted via the second parking jack 52 and a second valve electronics 54 by means of the control device 16. The second parking brake valve 56 is connected to the shuttle valve 60 via a second brake control line 58. The shuttle valve 60 is configured so as to conduct a pressure forward when a pressure is applied on at least the first brake control line 48 or the second brake control line 58.

The first parking brake valve 46 and the second parking brake valve 56 are open in the energized state and closed in the unenergized state. When the first parking brake valve 46 is open, it conducts a pressure of the pressure input line 26 forward to the first brake control line 48. When the second parking brake valve 56 is open, it conducts a pressure of the pressure input line 26 forward to the second brake control line 58. The shuttle valve 60 is connected to the first relay valve 24 via a control pressure line 62 of the parking brake module 40 and the first input 63. The first relay valve 24 is configured so as to conduct a pneumatic pressure from the pressure input line 26 forward to the brake shuttle valve 36 when no pressure is applied on the first input 63. The brake shuttle valve 36 is configured so as to conduct a pressure forward to the brake pressure output line 22 and thus to the brake 14 when a pressure is applied on at least one of the inputs of the brake shuttle valve 36. The parking brake module 40 thus comprises a redundant control of the parking brake function, because, in the event of a malfunction of the parking brake valve 46 or 56, the respective other parking brake valve 46 or 56 continues to provide a parking brake function.

The service brake module 70 comprises the operating jack 72, a brake electronics 74, the pressure sensor 76, a pilot valve 80, an outlet valve 82, and an inlet valve 84. The service brake module 70 is connected to the first relay valve 24 via the control pressure line 86 and the second input 87. The first relay valve 24 is configured so as to conduct a pneumatic pressure from the pressure input line 26 forward to the brake shuttle valve 36 when a pressure is applied on the second input 87. The pilot valve 80 is configured as a 3/2-way solenoid switch valve. The pilot valve 80 is configured so as to conduct a pneumatic pressure forward to the redundancy module 90 in the event of a malfunction of the service brake module 70. In an energized state, it connects a redundancy valve control line 100 to the ventilation line 32. In an unenergized state, it connects the pressure input line 26 to the redundancy valve control line 100 and thus conducts a pressure forward to the redundancy valve 102. The unenergized state of the pilot valve 80 can be set in the event of a malfunction of the service brake module 70.

The outlet valve 82 is configured as a 2/2-way solenoid switch valve. The outlet valve 82 is open in the unenergized state and closed in the energized state. The inlet valve 84 is configured as a 2/2-way solenoid switch valve and is open in the energized state and closed in the unenergized state. The outlet valve 82 and the inlet valve 84 are connected to the pressure input line 26 and the ventilation line 32. In an energized state, the inlet valve 84 is configured so as to conduct a pressure from the pressure input line 26 via the control pressure line 86 to the second input 87 of the first relay valve 24 and thus to trigger a braking. In an unenergized state, the outlet valve 82 is configured so as to discharge the pressure of the control pressure line 86 via the ventilation line 32 when a braking is no longer triggered.

The redundancy module 90 comprises the hydraulic input line 92 and a hydraulic sensor pressure line 94 for a hydraulic triggering. The redundancy module 90 also comprises the second relay valve 96, a redundancy brake pressure line 98, and the redundancy valve 102. The second relay valve 96 is connected to the redundancy valve 102 via a pressure line 104 of the second relay valve 96. The redundancy valve 102 is configured so as to be open in a pressurized state. It conducts a pressure from the pressure input line 26 forward to the pressure line 104 of the second relay valve 96 via the break-off valve 30. The redundancy valve 102 is configured as a 3/2-way valve. The redundancy valve 102 is controlled via the redundancy valve control line 100, which is connected to the pilot valve 80. The redundancy valve 102 is configured so as to ventilate the pressure line 104 via the ventilation line 32 in an unpressurized state.

The second relay valve 96 is configured so as to conduct a hydraulic pressure signal forward by way of pneumatic pressure. The hydraulic pressure is applied on the second relay valve 96 via the hydraulic input line 92. When a hydraulic pressure is applied on the second relay valve 96, the pressure line 104 is connected to the redundancy brake pressure line 98. When no hydraulic pressure is applied, the pressure line 104 is connected to the ventilation line 32. When no pressure is applied on the pressure line 104 of the second relay valve 96, no pressure is forwarded. When a pressure is applied on the pressure line 104 of the second relay valve, the pressure is conducted to the redundancy brake pressure line 98. The redundancy brake pressure line 98 is in turn connected to the brake shuttle valve 36. The brake 14 can thus be actuated via the redundancy module 90. A driver can thus actuate the brake 14 via the hydraulic input line 92, even in the event of a malfunction of the service brake module 70.

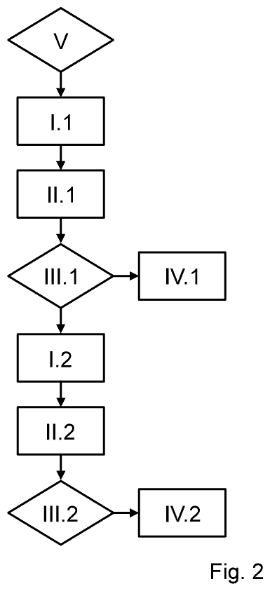

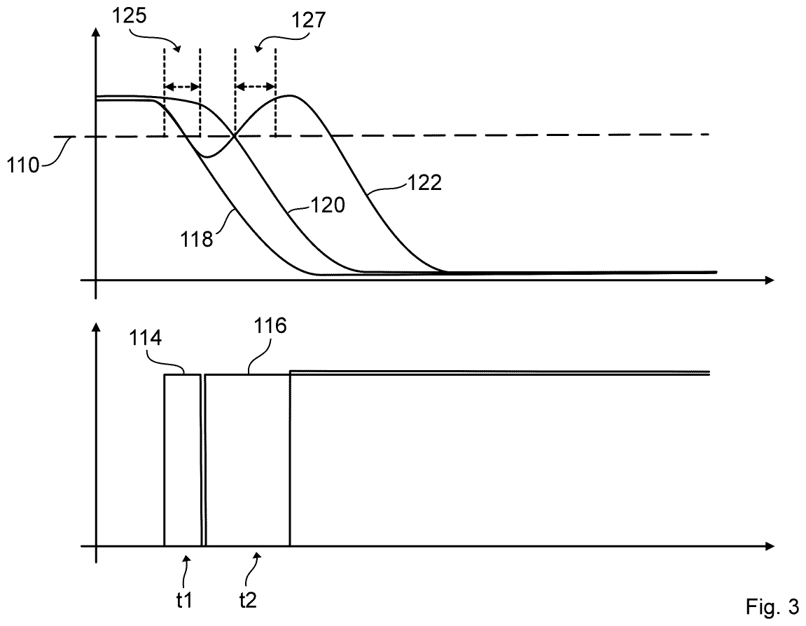

FIG. 2 shows a flowchart of a method for detecting a malfunction of the first parking brake valve 46 and the second parking brake valve 56 of the braking device 10 from FIG. 1 according to one embodiment of the present invention. The control device 16 of the braking device 10 is configured so as to carry out the method described below. FIG. 3 schematically illustrates brake pressure curves and control signals in the braking device 10 when carrying out the method steps shown in FIG. 2. The upper half of FIG. 2 schematically shows three possible pressure curves, which are applied on the brake pressure output line 22 and can be measured by the pressure sensor 76. The time is plotted along the horizontal axis and the measured pressure is plotted along the vertical axis. The lower half of FIG. 2 schematically shows the control signals 114 and 116 of the first parking brake valve 46 and the second parking brake valve 56, by means of which the parking brake valves 46 and 56 are triggered by means of the control device 16.

In a first step I.1 of the method shown in FIG. 2, the first parking brake valve 46 of the braking device 10 shown in FIG. 1 is triggered by the control device 16, as can be seen from the control signal 114 of the first parking brake valve 46 in the lower diagram of FIG. 3. By the triggering I.1 of the valve 46, an opening of the valve is initiated. However, if the parking brake valve 46 is not triggered, it is closed. During the time period t1 in FIG. 3, the parking brake valve 46 is thus triggered, and thereafter the parking brake valve 46 is no longer triggered. The first parking brake valve 46 is energized and opened by the triggering I.1, resulting in a pressure drop in the brake pressure output line 22, provided there is no malfunction in the first parking brake valve 46. If the first parking brake valve 46 functions as intended, an intended brake pressure curve 118 is established, as shown in FIG. 3.

FIG. 3 further shows a first faulty brake pressure curve 120, which represents a possible brake pressure curve in the event of a malfunction of the first parking brake valve 46. The parking brake valve 46 is triggered the same way in both cases. In the first faulty brake pressure curve 120, however, the brake control pressure initially remains essentially unchanged and does not decrease as in the case of the fault-free brake pressure curve 118. The underlying malfunction can be, for example, a defective valve, but also a defective first valve electronics 44 or a first brake control line 48. Due to the malfunction, no pressure is conducted via the shuttle valve 60 to the first relay valve 24, as a result of which the brake pressure does not drop and the brake 14 is not initiated.

After a first waiting period 125, a step of determination II.1 of a state variable is carried out, wherein the state variable is the pressure along the brake pressure output line 22, which is determined in the present embodiment via the pressure sensor 76. If there is no malfunction of the parking brake valve 46, the pressure drops below the reference value 110 shown in FIG. 3 during the first waiting period 125. Consequently, in a subsequent step III.1, the determined state variable, i.e., the pressure in the brake pressure output line 22, is compared to the reference value 110. If the comparison III.1 leads to the result that the pressure determined in step II.1 lies above the reference value 110, a malfunction of the first valve is detected by the control device 16 in a subsequent step IV.1. In this case, the control device 16 sends a signal to the driver in step IV.1 and informs the driver about the detected malfunction of the parking brake valve 46. If the determined pressure lies below the reference value 110, it is determined in step IV.1 that the parking brake valve 46 is functioning as intended.

Subsequently, after a first period t1, starting from the start of the triggering I.1 of the first valve 46, a further triggering I.2 of the second valve is carried out in step IV.1. At the start of the triggering I.2 of the second valve 56, the first valve 46 is no longer actuated in the present case, for which reason it is closed. The control device 16 opens the second parking brake valve 56 according to the above description regarding the first parking brake valve 46, as a result of which the pressure on the brake pressure output line 22 continues to drop along the fault-free brake pressure curve 118 as described above, if there is no malfunction in the second parking brake valve 56. If, on the other hand, the first parking brake valve 46 has been faulty, such that the first faulty brake pressure curve 120 has been set, the pressure drops along the curve 120 in case of a fault-free second parking brake valve 56, as shown in FIG. 3. If, on the other hand, only the second parking brake valve 56 is faulty, the pressure increases from the curve 118 in order to now follow the second faulty brake pressure curve 122 shown in FIG. 3. The second faulty brake pressure curve 122 initially follows the fault-free brake pressure curve 118 until it increases relative thereto, as described above.

After a second waiting period 127, starting from the further triggering I.2 of the second parking brake valve 56, a step of further determination II.2 of a further state variable is now therefore carried out. The further state variable is the pressure along the brake pressure output line 22, which is also determined via the pressure sensor 76. If there is no malfunction of the second parking brake valve 56, the pressure remains at or falls below the reference value 110 during the second waiting period 127. This corresponds to the fault-free brake pressure curve 118 or the brake pressure curve 120. Otherwise, the pressure now increases above the reference value 110 according to the curve 122. Therefore, a step of further comparison III.2 of the determined state variable is carried out, in which the determined pressure is compared to the reference value 110. If the determined pressure lies above the reference value 110, a malfunction of the second parking brake valve 56 is detected in a subsequent step IV.2 by the control device 16 and output to the driver according to the above description. Otherwise, it is determined that there is no malfunction in the second parking brake valve 56.

After a second period t2 starting from the further triggering I.2 of the second parking brake valve 56, the first parking brake valve 46 is triggered again, wherein both parking brake valves 46 and 56 are opened and a parking brake function is initiated.

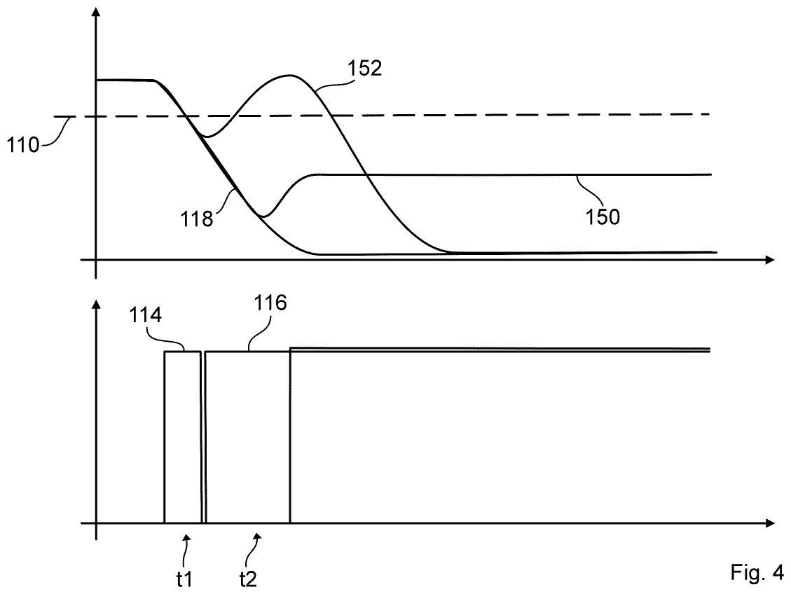

In the present embodiment, prior to the functional check of the parking brake valves 46 and 56, which begins with the triggering I.1 of the first parking brake valve 46, a check step V is carried out as to whether the service brake module 70 is operated above a limit value. In the present embodiment, it is checked whether the service brake module 70 applies a pressure above a limit value on the brake pressure output line 22. Such a pressure applied by the service brake module 70 could falsify the detection IV of a malfunction of the first parking brake valve 46 or the second parking brake valve 56. Accordingly, the method of the present embodiment is only carried out when the service brake module 70 is not operated above the limit value. As can be seen from FIG. 4, the actuation of the service brake module 70 can influence the pressure curve in the brake pressure output line 22, as shown by the curves 150 and 152. The deviations of the curves 150 and 152 from the pressure curve 118 are caused here by the actuation of the service brake module 70. FIG. 4 is otherwise constructed according to the above explanations regarding FIG. 3.

In an alternative embodiment, the parking brake module 40 comprises a control pressure sensor line 140 and a control pressure sensor 142, which are shown by dashed lines in FIG. 1. The control pressure sensor 142 measures the control pressure on the control pressure line 62 via the control pressure sensor line 140. A pressure that is not influenced by the service brake module 70 or the redundancy module 90 can thus be determined. Disruptions of these components can thus be avoided when detecting a malfunction of the first parking brake valve 46 or the second parking brake valve 56. Otherwise, this alternative embodiment corresponds to the embodiment described above in connection with FIG. 1. Furthermore, the method from FIG. 2 can also be carried out in this alternative embodiment according to the above explanations.

In an alternative embodiment, the parking brake module 40 comprises a first parking brake sensor line 130, a first parking brake pressure sensor 132, a second parking brake sensor line 134, and a second parking brake pressure sensor 136. These are shown by dashed lines in FIG. 1. The first parking brake pressure sensor 132 measures via the first parking brake sensor line 130 the pressure conducted via the first parking brake valve 46. The second parking brake pressure sensor 136 measures via the second parking brake sensor line 134 the pressure conducted via the second parking brake valve 56. Thus, two separate pressures can be determined before a merging via the shuttle valve 60. By comparing the two determined pressures to a reference value 110, a malfunction of the first parking brake valve 46 or the second parking brake valve

56 can thus be determined. This also makes it possible to detect a malfunction when both parking brake valves 46 and 56 are triggered at the same time. The first parking brake pressure sensor 132 and the second parking brake pressure sensor 136 are connected to the control device 16. Otherwise, this alternative embodiment corresponds to the embodiment described above in connection with FIG. 1. Furthermore, the method from FIG. 2 can also be carried out in this alternative embodiment according to the above explanations.

### LIST OF REFERENCE NUMERALS

10 Braking device
14 Brake
16 Control device
20 Housing
22 Brake pressure output line
24 First relay valve
26 Pressure input line
28 Pressure output line
30 Break-off valve
32 Ventilation line
34 Sound absorber
36 Brake shuttle valve
40 Parking brake module
42 First parking jack
44 First valve electronics
46 First parking brake valve
48 First brake control line
52 Second parking jack
54 Second valve electronics
56 Second parking brake valve
58 Second brake control line
60 Shuttle valve
62 Control pressure line
63 First input
70 Service brake module
72 Operating jack
74 Brake electronics
76 Pressure sensor
78 Sensor pressure line
80 Pilot valve
82 Outlet valve
84 Inlet valve
86 Control pressure line
87 Second input
90 Redundancy module
92 Hydraulic input line
94 Hydraulic sensor pressure line
96 Second relay valve
98 Redundancy brake pressure line
100 Redundancy valve control line
102 Redundancy valve
104 Pressure line
110 Reference value
114 Control signal of the first parking brake valve
116 Control signal of the second parking brake valve
118 Fault-free brake pressure curve
120 First faulty brake pressure curve
122 Second faulty brake pressure curve
125 First waiting period
127 Second waiting period
130 First parking brake sensor line
132 First parking brake pressure sensor
134 Second parking brake sensor line
136 Second parking brake pressure sensor
140 Control pressure sensor line
142 Control pressure sensor
150 Fourth brake pressure curve
152 Fifth brake pressure curve
I.1 Triggering of the valve
I.2 Triggering of the further valve
II.1 Determination of a state variable
II.2 Determination of a further state variable
III.1 Comparison of the determined state variable
III.2 Comparison of the determined further state variable
IV.1 Detection of a malfunction of the valve
IV.2 Detection of a malfunction of the further valve
V Check of the operation of the service brake module
t1 First period
t2 Second period

1. A method for detecting a malfunction of a valve (46) of a braking device (10) for a processing machine, wherein the braking device (10) has a brake (14) that can be actuated via the valve (46) and a transmission portion, the method comprising:
triggering (I.1) the valve (46) of the braking device (10);
determining (II.1) a state variable in the transmission portion (22);
comparing (III.1) of the determined state variable to a reference variable; and
detecting a malfunction of the valve (46) based on a result of the comparison.

2. The method according to claim 1, wherein the braking device (10) comprises a further valve (56) for actuating the brake (14) via a further transmission portion (22) and wherein the method comprises:
further triggering (I.2) the further valve (56) of the braking device (10) further determining a further state variable in the further transmission portion (22);
further comparing the determined further state variable to a reference variable, and further detecting a malfunction of the further valve (56) based on a result of the further comparison (III.2).

3. The method according to claim 2, wherein the transmission portion and the further transmission portion comprise a common transmission portion (22), and wherein further determining the state variable comprises a determination (II.1, II.2) of a state variable in the common transmission portion (22).

4. The method according to claim 2 wherein further triggering (I.2) the further valve (56) takes place temporally after the triggering (I.1) of the valve (46).

5. The method according to claim 1, wherein detecting the malfunction of the valve (46, 56) comprises determining that the determined state variable is greater than the reference variable.

6. The method according to claim 1, wherein determining the state variable in the transmission portion (22) comprises determining a pressure in the transmission portion (22).

7. The method according to claim 1, wherein determining the state variable is carried out after triggering (I.1; I.2) the valve with a temporal delay representing a waiting period (125; 127).

8. The method according to claim 1, wherein the braking device (10) comprises a parking brake module (40) with the valve (46) configured for parking the processing machine and a service brake module (70) configured for service-braking the processing machine, and wherein the method comprises checking whether the service brake module (70) is operated above a limit value.

9. A control device (16) for a braking device (10) of a processing machine, the control device configured so as to carry out the method according to claim 1.

10. A braking device (10) for a processing machine having a control device (16) configured to carry out the method according to claim 1.
